(19) United States
(12) Patent Application Publication
(10) Pub. No.: US 2003/0039523 A1
(43) Pub. Date: Feb. 27, 2003

(54) Drilling or boring tool

(75) Inventor: Klaus Kemmer, Wildberg (DE)

Correspondence Address: OSTROLENK FABER GERB & SOFFEN, 1180 AVENUE OF THE AMERICAS, NEW YORK, NY, 100368403

(73) Assignee: Kemmer Hartmetallwerkzeuge GmbH

(21) Appl. No.: 10/194,657

(22) Filed: Jul. 11, 2002

(30) Foreign Application Priority Data
Jul. 13, 2001 (DE) 20111666.9
Nov. 12, 2001 (DE) 10156485.6
Apr. 15, 2002 (DE) 10217250.1
Jul. 9, 2002 (DE) 10231382.2

(51) Int. Cl. B23B 51/02

(52) U.S. Cl. 408/231

(57) ABSTRACT

A three-flute drilling or boring tool having a shank which has a spiral-flute region. The tool has end-face geometry which is arranged on an interchangeable head fastened to the shank. Torque-transmitting projections and recesses or tooth systems are provided on or in the facing parting surfaces and are provided between the shank and the interchangeable head.

### BACKGROUND OF THE INVENTION

The invention relates to a drilling or boring tool preferably having at least one cutting edge, but in particular having three cutting edges on a cutting head and relates to attachment of the cutting head to the shank of the tool.

Tools of this type are known. They serve to machine workpieces. Each such tool comprises a shank which has an end-face geometry comprising a spiral-flute region and a plurality of cutting edges. The end-face geometry and the spiral-flute region are cut out of a solid material, for example carbide, by grinding. The end-face geometry of the tool and in particular its cutting edges are subjected to wear, so that after a certain time they have to be re-sharpened and re-coated. On account of the complicated end-face geometry, this can only be done in special grinding shops. A disadvantage in this case is that, when the tool is used in machine tools, a triple tool inventory is required, since normally one tool is located in the machine, a second tool is being re-ground/re-coated, and a third drilling tool is held in reserve. This leads to high circulation and inventory costs. A further disadvantage of the known tools is the fact that the tool change times are relatively long and thus so is the down time of the machine tool.

### SUMMARY OF THE INVENTION

The object of the invention is to provide a drilling or boring tool of the type mentioned herein without the above-mentioned disadvantages.

To achieve the object, a drilling and/or boring tool is distinguished by the fact that end-face geometry is arranged on an interchangeable head and that torque-transmitting means are provided between the shank and the interchangeable head. On account of this configuration, in the event of damage to or wear of the end-face geometry, in particular the cutting edges, the edges can be exchanged very quickly and in a simple manner without the entire drilling or boring tool having to be removed from the machine tool. The shank of the drilling or boring tool is normally held in the machine tool by a clamping device and remains clamped in place during an exchange of the interchangeable head, making a time-consuming adjustment of the tool unnecessary. Owing to the fact that it is possible to exchange the end-face geometry of the drilling or boring tool in a very short time and in a simple manner, the downtime of the machine tool can be reduced and its productivity can be increased. Furthermore, it is advantageous that a plurality of complete drilling or boring tools need not be provided for each machine tool, since normally only the end-face geometry wears out and accordingly and has to be renewed or exchanged.

The drilling or boring tool according to the invention comprises drilling or boring tools with one or more than one cutting edge, that is, the drilling or boring tool may have, for example, two, three, four or even more cutting edges, wherein drilling or boring tools having three cutting edges are preferred.

In an advantageous exemplary embodiment of the drilling or boring tool, the torque-transmitting means is arranged at a distance from an imaginary circumferential circle determining the drill/bore hole diameter. They therefore do not extend into the radially outer region of the drilling/boring tool in which the cutting edges of the tool are located. This configuration enables a firm and reliable connection between an interchangeable head and shank even in the case of shanks which, seen in cross section have only small wall/material thicknesses.

An exemplary embodiment of the drilling/boring tool is proposed in which the shank has a flat, first parting surface and the interchangeable head has a flat, second parting surface which bear flat against one another in the mounted state of the interchangeable head. These parting surfaces are preferably formed in each case by an end face of the shank and of the interchangeable head. Because the parting surfaces have no complicated contour/geometry, which is therefore expensive to produce, but instead is of flat design, these parting surfaces can be machined in a simple and cost-effective manner, for example by grinding.

According to a development of the invention, provision is made for a first torque-transmitting means to be formed by a projection starting from the first or the second parting surface, and for a second torque-transmitting means to be formed by a recess in the second or the first parting surface, wherein the projection is arranged in the recess, in the mounted state of the interchangeable head. The projection and the recess thus form a peg/hole connection, which can be produced in a relatively simple and thus cost-effective manner. The projection may thus be arranged on both the shank and the interchangeable head. In that case, depending on which of the two functional elements (shank, interchangeable head) the projection is located, the recess is arranged on the other respective functional element. The projection and, if need be, also the recess are preferably arranged in a region of their parting surface in which the shank or the interchangeable head, respectively—as seen in cross section—has a relatively large material thickness and is thus designed to be thick-walled. As a result, even during the transmission of high torques from the shank to the interchangeable head or from the interchangeable head to the shank, a firm and reliable connection between an interchangeable head and shank can be ensured.

A preferred embodiment provides for there to be only little play or no play at all between a projection and recess in the mounted state of the interchangeable head, in which state the projection engages in or is arranged in the recess. This ensures that only a very small relative movement—if at all—is possible between an interchangeable head and shank in the circumferential direction of the drilling/boring tool.

An especially preferred embodiment of the drilling/boring tool is distinguished by the fact that the respective shapes of the projection and the recess are selected and adapted to one another in such a way that, when the interchangeable head is attached to the shank, the interchangeable head is centered relative to the shank. As a result, exact alignment of the interchangeable head relative to the shank and—if the drilling/boring tool is rotationally driven about its longitudinal center axis during the machining of a component—accurate concentric running of the drilling/boring tool can be ensured. Additional centering means may therefore be dispensed with.

An advantageous exemplary embodiment provides for the outer contour of the projection to correspond to the inner contour of the recess. This causes the projection and the recess to bear against one another at a surface region which is relatively large in relation to the overall area of the projection. Linear or edge contact between projection and recess, a factor which leads to a high surface pressure during the machining of a workpiece by means of the drilling/boring tool, can thus be reliably avoided here.

An especially advantageous embodiment of the drilling/boring tool has the projection formed by a cylindrical pin which, after the parting surface has been machined, can be inserted into a receptacle provided in the latter. The flat parting surfaces can therefore be machined in a simple manner, for example by face grinding, since the parting surfaces have no disturbing edges. The pin is a separate functional element, which may also be made of a different material from the interchangeable head or the shank. Another variant of the drilling/boring tool provides for the projection to be formed in one piece with the shank or the interchangeable head. This may be advantageous, for example, when the shank or the interchangeable head is produced by sintering, so that a further machining step is possibly not necessary.

A development of the invention provides for a plurality of first and a plurality of second torque-transmitting means, and in each case a first and a second torque-transmitting means interact with one another. The first and second torque-transmitting means may be designed like the torque-transmitting means described above. It is advantageous if the torque-transmitting means which are arranged at a distance from the imaginary circumferential circle, determine the drill/bore hole diameter, and that they be arranged so as to be uniformly distributed, as seen in the circumferential direction of the drilling or boring tool. In this arrangement of the torque-transmitting means, to ensure that in each case the same first and second torque-transmitting means interact with one another or are assigned to one another when the interchangeable head is attached, an advantageous exemplary embodiment provides at least one first torque-transmitting means and a second torque-transmitting means interacting with the first torque-transmitting means to have a shape and/or size differing from the remaining torque-transmitting means. This ensures that there is preferably only one possible way of attaching the interchangeable head to the shank. This is especially advantageous in a drilling/boring tool in which the interchangeable head has a spiral-flute region, so that, the torque-transmitting means of different design always connects the interchangeable head to the shank with the spiral flutes in alignment.

An advantageous exemplary embodiment provides the projection and the recess with a longitudinal extent in the radial direction toward the rotation axis. As a result, the surface region in which the projection and the recess bear against one another and which effects the torque transmission can be designed to be relatively large. On account of the large surface region, relatively low component loading results during operation in the region of the torque-transmitting means. It is advantageous if the projection and the recess are of rectilinear design in the direction of their longitudinal extent. Furthermore, it is advantageous if the projection and the recess extend up to the outer circumferential surface of the drilling/boring tool. Each of these two measures leads to a low production cost during the manufacture of the drilling/boring tool. Furthermore, favorable torque-transmitting ratios are obtained, since no force distribution occurs with components which either do not serve or do not adequately serve to transmit the torque.

Provided the outer contour of the projection and the inner contour of the recess are polygonal, and preferably trapezoidal, that is with trapezoidal cross-sectional structures, the trapezoidal angles of both sides relative to the larger base line or smaller top line preferably have the same size, the base line preferably runs at right angles to the rotation axis, the parting surfaces preferably run at right angles to the rotation axis and coincide with the base line, and there is in particular such a torque-transmitting geometry in which a projection/recess arrangement is assigned to the shank sector (spiral-web region) assigned to each cutting edge. An especially preferred embodiment is obtained.

The subject matter of the invention also relates to a drilling or boring tool having features which in particular have the advantage that the transmission of high torques is made possible in the connecting region of the shank and the interchangeable head even when they have small wall/material thicknesses.

According to a preferred embodiment of the invention, a first torque-transmitting means has at least one projection which is arranged on the shank and starts from one parting surface, and a second torque-transmitting means has at least one recess which is formed on the interchangeable head and starts from the other parting surface. Consequently, the at least one projection is assigned to the shank and the at least one recess is assigned to the interchangeable head. The projection protrudes in a direction which runs parallel to the longitudinal center axis of the tool. The recess has the shaping and position of the projection on the interchangeable head. If the interchangeable head is axially assigned to the shank and fastened by suitable fastening means, the projection and recess interlock free of play for the axial and radial orientation of shank and interchangeable head and for the torque transmission.

A plurality of projections and accordingly a plurality of recesses are preferably provided. The projections and recesses preferably lie at uniform angular distances from one another, that is they are arranged around the longitudinal center axis of the tool. In particular, there are three projections and corresponding recesses offset from one another by an angle of 120°.

The torque-transmitting means start from the outer margin of the shank and also from the outer margin of the interchangeable head. This means that the projections or the at least one projection start or starts from the outer margin of the shank and run or runs radially in the direction of the longitudinal center axis. The same correspondingly applies to the recesses, that is they start at the outer margin of the interchangeable head and run radially inward in the direction of the longitudinal center axis of the tool. The same correspondingly applies to only one recess. Alternatively, it is possible for both the projection or projections and the recess or recesses not to start from the outer margin of shank and interchangeable head but to be at a distance from the margins. That means that the projections and recesses cannot be seen when looking toward the tool from outside and torque transmission does not extend up to the outer margin.

Starting from the outer margin of the shank or from the outer margin of the interchangeable head, the torque-transmitting means preferably run up to an imaginary circumferential line, that is they do not extend radially up to the longitudinal center axis of the tool but only up to the imaginary circumferential line. The center point of that line lies on the longitudinal center axis. In this respect, the torque-transmitting means leave a central region clear, so that the fastening means for interchangeable fastening of the interchangeable head on the shank can be accommodated in this clearance space.

In particular, the projection does not have the same height overall but, as seen in the radial direction from the outside to the inside, it becomes smaller. Those sides of the projection and recess which effect the torque transmission are designed accordingly. The projection therefore has a greater height where the radius of the tool is greater than further on the inside in a region in which the tool radius is smaller. In that case, there is accordingly also a smaller height of the projection. The same correspondingly applies to the design of the associated recess, that is the depth of the recess is greater radially further on the outside than in regions which lie radially further on the inside. In particular, the height of the projection may decrease continuously toward the inside. Accordingly, the depth of the recess decreases from the outside to the inside—likewise preferably continuously. In such cases, the top surface of the projection is designed as a sloping plane and the root of the recess accordingly forms a sloping plane.

The result of the configuration with a greater projection height further on the outside is that, during torque transmission, larger side surfaces of projection and recess bear against one another where greater torques are also to be transmitted. Of course, the torque characteristic decreases from the outside to the inside during the force transmission from the shank to the interchangeable head. The correspondingly varying heights of the projection and depth of the recess ensure reliable torque transmission from the shank to the interchangeable head takes place without “overturning” occurring, that is without the at least one projection being forced out of its associated recess and without relative rotation between shank and interchangeable head until the projection catches again in another recess or in the recess.

Furthermore, it is advantageous if the essentially radially running sides of the projection, as seen in the direction toward the interchangeable head, converge toward one another. Accordingly, the sides of the recess (in the direction of view from the interchangeable head toward the shank) diverge. In this case, the sides of the projection are designed as flat surfaces and the corresponding side walls of the recess are likewise designed as flat surfaces. The sides of the projection may converge by both sides being at an angle to the parting surface which is greater than 90°. In particular, the projections, as viewed in cross section, have a symmetrical trapezoidal shape. Alternatively, they may also have an asymmetrical trapezoidal shape; that is the two angles of the sides are of different size with respect to the associated parting surface. However, the sides of the projection also converge if one side encloses a 90° angle with the parting surface and the other side has an angle which is greater than 90°. With regard to the direction of rotation of the torque, it is advantageous if it acts on that side of the projection and the recess which has an angle of 90° to the associated parting surface. In this way, the “overturning” mentioned above is prevented in an even more reliable manner, since no sloping surfaces bear against one another. Sloping surfaces having the tendency to move relative to one another, that is they promote a movement of the interchangeable head in the axial direction relative to the shank when very large torques are to be applied.

It is advantageous if, for radial and axial interlocking free of play, the recess is designed so as to be adapted in shape to the projection. There is preferably contact over a large area. This promotes reliable torque transmission and in addition ensures exact orientation of the interchangeable head relative to the shank in the radial and axial directions. In particular, it is advantageous that the two sloping side surfaces of the projection touch the sloping side surfaces of the associated recess and that there is only a slight distance or no distance at all between the parting planes of the interchangeable head and the shank, so that, when the interchangeable head and shank are restrained in the axial direction, the sloping surfaces of the projection and recess are drawn onto one another very tightly.

Furthermore, it is advantageous if the interchangeable head is held on the shank in an interchangeable manner by releasable fastening means. This has been described above. In this case, the fastening means may be a stud bolt or a screw which passes through a central through-opening of the interchangeable head, which is supported with a head or a step on the interchangeable head and is screwed into a central tapped hole of the shank. The head or the step is preferably sunk into the interchangeable head. Consequently, a counterbored hole for accommodating the head or step is provided on the interchangeable head in the direction of the longitudinal center axis. In this region, therefore, no cutting edge of the tool can be formed, so that the boring tool type which is used here is preferably one which only requires peripheral cutting edges.

The invention is explained in more detail below with reference to the drawings:

### BRIEF DESCRIPTION OF THE DRAWINGS

FIG. 1 shows a side view of a first exemplary embodiment of a three-flute drilling/boring tool, partly sectioned;

FIG. 2 shows a side view of an interchangeable head, shown in FIG. 1, of the drilling/boring tool;

FIG. 3 shows a sectional representation of the interchangeable head, shown in FIG. 2, along section line section line A-A;

FIG. 4 shows a side view of a shank of the drilling/boring tool shown in FIG. 1;

FIG. 5 shows a plan view of a parting surface of the shank shown in FIG. 4;

FIG. 6 shows a plan view of a parting surface of a further exemplary embodiment of the interchangeable head;

FIGS. 7A to 9B each show an exemplary embodiment of a torque-transmitting means arranged between the interchangeable head and the shank;

FIGS. 10 and 11 each show a view of a further exemplary embodiment of the interchangeable head;

FIGS. 12 and 13 each show a view of an interchangeable head and shown in FIGS. 10 and 11 provided for the shank;

FIGS. 14 and 15 each show a view of a further exemplary embodiment of the tool shank;

FIGS. 16 to 21 each show a further embodiment of the interchangeable head;

FIG. 22 shows a side view of a further exemplary embodiment of the drilling or boring tool according to the invention, partly sectioned;

FIG. 23 shows a further embodiment of a drilling or boring tool;

FIG. 24 shows a schematic detail view of the embodiment in FIG. 23;

FIG. 25 shows a partial view of the embodiment in FIG. 23;

FIG. 26 likewise shows a partial view of the embodiment in FIG. 23 ;

FIG. 27 shows a further embodiment of a drilling or boring tool;

FIG. 28 shows a detail view of the embodiment in FIG. 27;

FIG. 29 shows a partial view of the embodiment in FIG. 27, and

FIG. 30 shows a partial view of the embodiment in FIG. 27.

### DESCRIPTION OF PREFERRED EMBODIMENTS

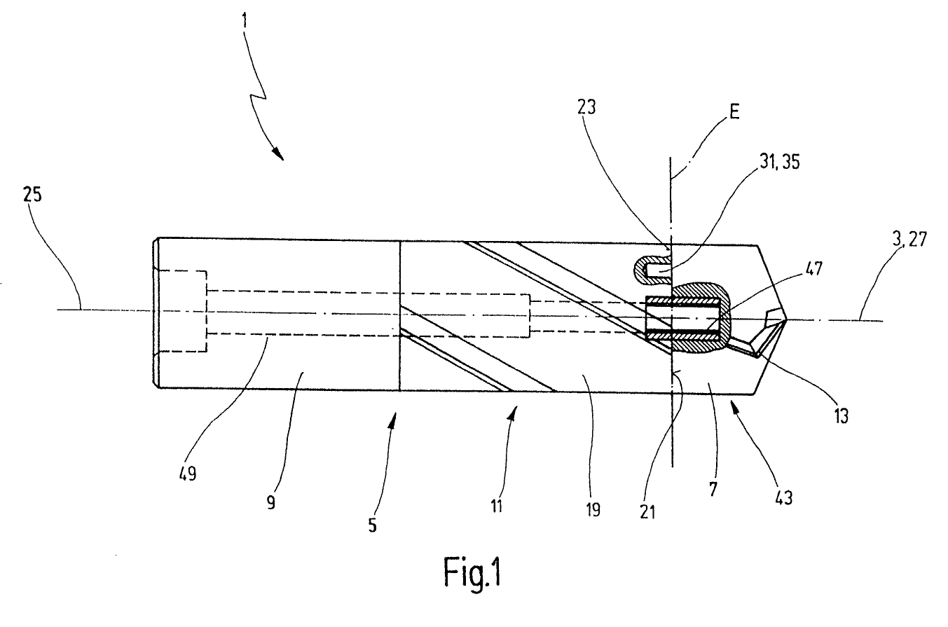

FIGS. 1 to 5 each show a view of an exemplary embodiment of a drilling and boring tool 1 which has three cutting edges. An existing hole can be enlarged or drilling in the solid with the tool. During machining of a workpiece, chips are removed from it. In the process, the drilling/boring tool 1 generally performs a circular cutting movement and at the same time a feed movement in the direction of its rotation axis 3. In some cases, the cutting movement is effected by the revolving workpiece, for example when drilling is performed on a lathe.

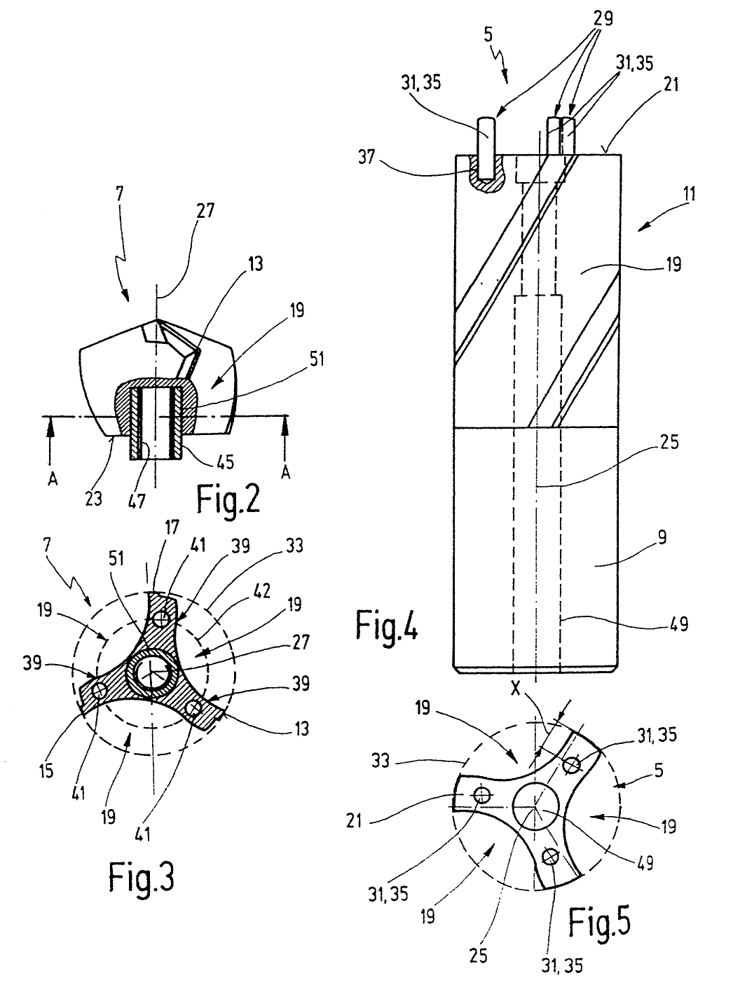

In FIG. 1, the drilling/boring tool 1 is designed as a twist drill and is shown in the assembled state. It comprises a shank 5 and an interchangeable head 7 arranged thereon at the end. The shank 5 has a clamping region 9 and a spiral-flute region 11 with three spiral flutes and three spiral webs lying between the spiral flutes. The shank 5 is held in the clamping region 9 by a suitable clamping device of a machine tool. Therefore, the tool 1 is a three-flute cutter, that is the interchangeable head 7 has three cutting edges 13, 15, 17, as seen in FIG. 3, which shows a plan view of the interchangeable head 7 along the section line A-A shown in FIG. 2. The three cutting edges 13, 15, 17 form main cutting edges in the end-face region and secondary cutting edges in the shank region.

Furthermore, the tool 1 comprises a number of helical flutes 19 corresponding to the number of cutting edges 13,15 and 17, here three flutes, which permit the removal of the chips. The flutes 19, like the cutting edges 13 to 17, are uniformly distributed in the circumferential direction of the tool 1, at a distance apart of 120°.

The shank 5 has a first parting surface 21, which is flat and at right angles to the rotation axis 3. In the mounted state, shown in FIG. 1, the interchangeable head 7 bears with a second parting surface 23, which is likewise flat against the surface 21. The parting surfaces 21, 23 are respectively located on an end face of the shank 5 and on an end face of the interchangeable head 7 on an interface between shank 5 and interchangeable head 7 indicated by a parting plane E, in which the parting surfaces 21, 23 (flat faces) are located. The parting plane E runs orthogonally to the longitudinal center axis/rotation axis 3 of the tool 1, which coincides with the longitudinal center axes 25 of the shank 5 and 27 of the interchangeable head 7.

Furthermore, the tool 1 comprises torque-transmitting means for the rotationally locked coupling of shank 5 and tool head 7. Those means are arranged between the shank 5 and the tool head 7 and are at a radial distance from the longitudinal center axis 3 of the drilling/boring tool 1. They are explained below with reference to FIGS. 3 to 5. There are a total of three first torque-transmitting means 29, which in this embodiment are arranged on the shank 5. Each is formed by a projection 31, which projects from the first parting surface 21, as seen in FIG. 4. FIG. 5 shows the projections 31 arranged uniformly distributed in the circumferential direction at a distance apart of approximately 120°. Each projection 31 is at a radial distance x in from an imaginary circle 33 which determines the drill/bore hole diameter, indicated by broken lines in FIGS. 3 and 5. The circle 33 is defined by the radial distance of the cutting edges 13 to 17 from the longitudinal center axis 3 of the tool 1. FIG. 5 shows that the projections 31 are also arranged at a distance from those regions of the outer lateral surface of the shank 5 in which the three spiral flutes 19 are located. The projections 31 are thus virtually completely surrounded by the parting surface 21 and the projections project dome-like beyond the surface 21.

In the embodiment shown in FIGS. 1 to 5, each projection 31 is a cylindrical pin 35, particularly a precision pin, having a circular cross section. Each pin 35 is inserted into a receptacle 37 formed by a hole. One receptacle 37 is seen, in partial section, in FIGS. 1 and 4. The pins 35 are precisely fixed in their respective receptacles 37, for example, by a frictional connection caused by a press fit, or by an integral connection, and particularly therefore by brazing or adhesive bonding. The pins 35 are separate parts, which are preferably arranged on the shank 5 as described above after the first flat parting surface 21 has been finished. The first parting surface 21 can therefore be produced in a simple manner, for example by face grinding.

Each first torque-transmitting means 29 interacts with a second torque-transmitting means 39 in the exemplary embodiment of FIGS. 1 to 5. The means 39 are arranged on the interchangeable head 7, since the first torque-transmitting means 29 are located on the shank 5. A total of three second torque-transmitting means 39 are provided. Each is formed by a recess 41 in the second parting surface 23 of the interchangeable head 7. Each recess has a circular cross section and it may be produced, for example, by drilling or, if the interchangeable head 7 is a sintered part, by sintering using corresponding cores in a sintering die. The second torque-transmitting means 39 are also arranged at a radial distance from the circumferential circle 33 which determines the drill/bore hole diameter and also at a distance out from the remaining regions of the outer circumferential surface of the interchangeable head 7.

FIG. 3 shows the center point of the recesses 41 located on an imaginary circle 42, indicated by broken lines, with a center point on the longitudinal center axis 27 of the interchangeable head 7. The circle 42 is preferably concentric with the circumferential circle 33 that is, in this embodiment, the recesses 41, like the projections 31 on the shank 5, are at the same radial distance from the longitudinal center axis 27.

When the interchangeable head 7 and the shank 5 are being joined, they are oriented to one another in the circumferential direction such that each of the recesses 41 is located opposite a respective associated projection 31. Axial relative movement between shank 5 and interchangeable head 7 inserts the projections 31 into the recesses 41 until the parting surfaces 21, 23 bear flat against one another, as shown in FIG. 1. The projections 31 and recesses 41 are assigned in such a way that, when the interchangeable head 7 and the shank 5 are being joined, the recesses 41 are in alignment with their spiral flutes. The flutes 19 have a first longitudinal section arranged on the shank 5 in the spiral-flute region 11 and have a second longitudinal section arranged on the interchangeable head 7, namely in a spiral-flute region 43. The flutes have a continuous helical form.

The embodiment of the tool 1 described with reference to FIGS. 1 to 5 has three cutting edges and has the outer contour of a known, three-flute drilling/boring tool which is ground from solid material. The transition from the spiral-flute region 43 of the interchangeable head 7 to the spiral-flute region 11 of the shank 5 is preferably designed to be smooth, i.e. the interchangeable head 7 and the shank 5 have identical cross-sectional areas in the region of their interface (at parting plane E).

A particular advantage of the arrangement according to the invention of the torque-transmitting means 29, 39 is that it produces a closed outer circumferential surface of the interchangeable head 7 and of the shank 5. In contrast to known tools, this outer circumferential surface is not interrupted by the torque-transmitting means 29, 39. Although the interchangeable head 7 and the shank 5 as seen in cross section, have only small material or wall thicknesses, firm and reliable connection between the interchangeable head 7 and the shank 5 can be ensured.

In the embodiment according to FIGS. 1 to 5, the interchangeable head 7 is secured to the shank 5 in the axial direction by a screw connection. The screw connection comprises a sleeve 45 which is arranged in the interchangeable head 7. The sleeve 45 has a tapped hole 47 therein, into which a threaded tie rod (not shown) is screwed. To this end, the shank 5 has a stepped passage 49 which passes concentrically through the shank 5 along its longitudinal center axis 25. The threaded tie rod is inserted into the passage 49 from that end face of the shank 5 which is remote from the interchangeable head 7. The thread of the screwed connection may alternatively be a right-hand thread or a left-hand thread. The sleeve 45 is only attached to the interchangeable head 7 when its parting surface 23 has been finish-machined, for example by face grinding.

FIG. 5 shows that the passage 49 has a circular cross section, at least in the region of its orifice in the parting surface 21. The sleeve 45 is inserted into and is fixed in a recess 51 in the second parting surface 23, for example it is brazed in place. The sleeve 45 projects a short distance above the second parting surface 23. In the mounted state of the interchangeable head 7, the sleeve 45 engages in the passage 49, preferably with little play. That longitudinal section of the sleeve 45 which projects beyond the second parting surface 23 is preferably shorter than that longitudinal section of the projections 31 which projects beyond the first parting surface 21 on the shank 5. In another embodiment, when the interchangeable head 7 is slipped onto the shank 5, provision is made for the sleeve 45 to first engage in the passage 49 before the projections 31 pass into the receptacles 41.

The arrangement and configuration of the projections 31 and receptacles 41 on the shank and interchangeable head 7, respectively, is preferably so precise that the interchangeable head 7 is exactly oriented relative to the shank 5 and, if required, is fixed in a frictional manner in the process.

The arrangement of the torque-transmitting means 29, 39 can also easily be transposed, that is, the first torque-transmitting means 29 may be arranged on the interchangeable head 7 while the receptacles 41 may be arranged on the shank 5. This has no effect on the functioning of the torque-transmitting means 29, 39. It is also conceivable for part of the first and part of the second torque-transmitting means 29, 39 to be arranged on the interchangeable head 7 and for the other respective part of the torque-transmitting means to be arranged on the shank 5.

In the simplest embodiment, the three-flute drilling/boring tool 1 described with reference to FIGS. 1 to 5 has two first and two second torque-transmitting means. Of course, more than three first and second torque-transmitting means may also easily be provided.

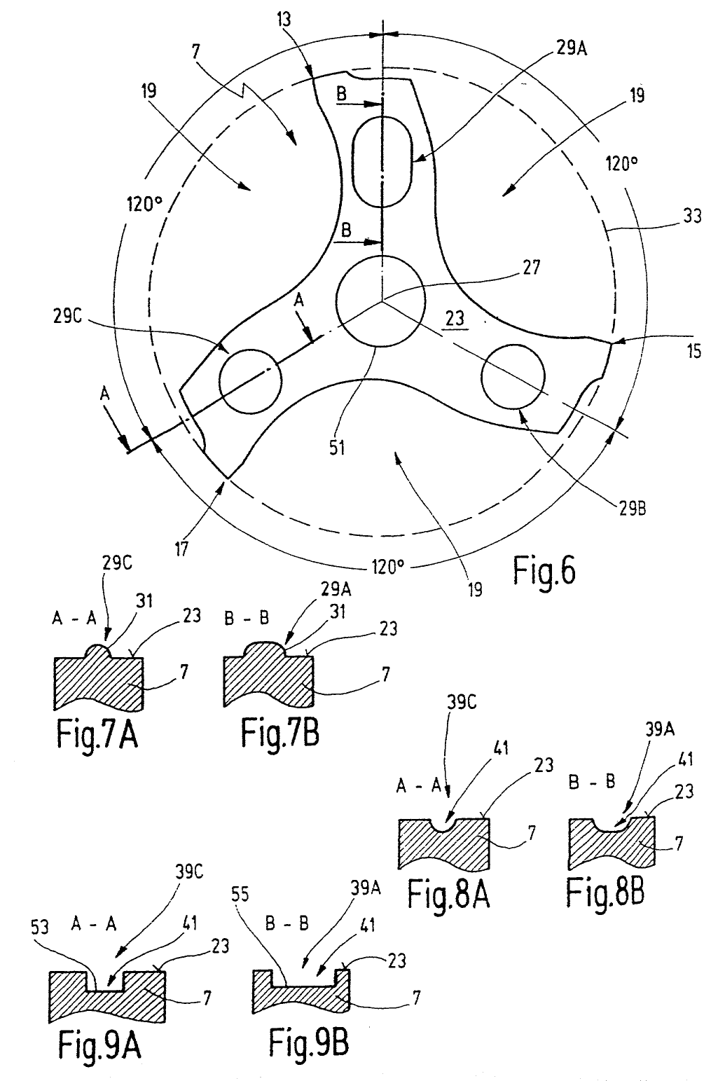

FIG. 6 shows a plan view of the parting surface 23 of a further embodiment of the interchangeable head 7. Parts already described with reference to the preceding Figures have the same reference numerals. Only the differences are discussed below. The interchangeable head 7 has three first torque-transmitting means 29A, 29B and 29C. Of these, the torque-transmitting means 29B and 29C are identical in shape and size. As seen in this plan view, they have a circular contour in the plane of the parting surface 23. The torque-transmitting means 29A differs in that it has an oval shape with a length greater than the diameter of the torque-transmitting means 29B, 29C.

FIG. 7A shows a cross section through the interchangeable head 7 along section line A-A shown in FIG. 6. It can be seen that the torque-transmitting means 29C, and thus the torque-transmitting means 29B of identical design, are formed by a projection 31 which starts from the flat parting surface 23 and is convexly arched, in particular hemispherical, and is in one piece with the interchangeable head 7. The first torque-transmitting means 29 assigned to the torque-transmitting means 39C and formed by a recess 41 arranged on the shank 5 (not shown) is designed such that the projection 31 is completely accommodated, so that the first and second parting surfaces 21, 23 of the shank 5 and of the interchangeable head 7, respectively, bear flat against one another. In a preferred embodiment, the inner contour of the recess 41 corresponds to the outer contour of the projection 31, that is the recess 41 has a concavely curved, for example spherical, and in particular hemispherical, inner contour.

FIG. 7B shows a cross section through the interchangeable head 7 along section line B-B in FIG. 6. It can be seen that the torque-transmitting means 29A is also designed in one piece with the interchangeable head 7 and has a convexly curved outer contour.

The torque-transmitting means 29A in FIG. 6 and the first torque-transmitting means 39A, which interacts with the torque-transmitting means 29A and arranged on the shank 5, differ in shape and size from the remaining torque-transmitting means 29B, 29C, 39B, 39C, to ensure that the interchangeable head 7 is always arranged on the shank 5 in the same way and is not offset by an angle in the circumferential direction, as would be theoretically possible, for example, in the embodiment described with reference to FIGS. 1 to 5. This configuration of the first torque-transmitting means 29A and of the associated, second torque-transmitting means on the shank 5 ensure that the interchangeable head 7 is always connected to the shank 5 with the spiral flutes in alignment.

FIGS. 8A and 8B and also 9A and 9B each show a detail of a further embodiment variant of the drilling/boring tool 1 according to the invention, in which the second torque-transmitting means 39 are arranged, for example, on the interchangeable head 7. Their representation corresponds to the section lines A-A and B-B, respectively, marked in FIG. 6. Thus, instead of including the first torque-transmitting means 29A to 29C, the interchangeable head 7, as seen in plan view, contains second torque-transmitting means 39A, 39B and 39C having the same contour. In this case, the torque-transmitting means 39 identified by “B” and “C” are also of identical design here, whereas the torque-transmitting means 39 identified by “A” is larger and also has a different shape.

FIG. 8A shows a longitudinal section through a second torque-transmitting means 39C which includes a recess 41, which here is shown with a hemispherical inner contour. In this embodiment, the first torque-transmitting means on the shank 5 is correspondingly designed as a projection 39, which is preferably likewise spherical. A further variant of the second torque-transmitting means 39C is shown in FIG. 9A. It is likewise formed of a recess 41 with a base 53 which, is flat and runs parallel to the second parting surface 23. The projection to be received in the recess 41 is preferably formed of a pin having a circular cross section, as described, for example, with reference to FIGS. 1 to 5. A common feature of both variants of the torque-transmitting means 39C is that they are in the second parting surface 23.

FIG. 8B shows an embodiment variant of the torque-transmitting means 39A which includes a concavely curved recess 41. FIG. 9B shows an embodiment of the torque-transmitting means 39A which includes a recess 41 having a flat base 55 running parallel to the second parting surface 23.

A common feature of all of the embodiments of the drilling and/or boring tool 1 which are described with reference to FIGS. 1 to 9B is that the first and second torque-transmitting means are arranged at a radial direction distance from the imaginary circle 33 determining the drill/bore hole diameter and are also at a radial distance from the remaining outer regions of the tool 1. The first and second torque-transmitting means therefore do not extend up to the outer circumferential surface of the tool 1, so that this outer circumferential surface can be closed, that is be free of recesses. Depending on the embodiment, whether they are designed as a projection or as a recess accommodating a projection, the first and second torque-transmitting means are embedded in the first parting surface 21 or the second parting surface 23, respectively, or project from the parting surface 21 or 23.

The projections 31 and recesses 41 may in principle have any desired configuration and are not restricted to the embodiments shown. At least one recess is assigned to each projection, the projection or the recess being arranged on the interchangeable head 7 and the other respective functional element being arranged on the shank 5.

The drilling and/or boring tool 1 according to the invention permits a very rapid change of the interchangeable head 7, which may be necessary, for example, as a result of wear or damage. The shank 5 can remain clamped in place in the machine tool, or the like. It is merely necessary to release the axial locking of the interchangeable head 7, which, in the embodiments of the tool 1 in FIGS. 1 to 5, is effected by the threaded tie rod passed through the passage 49 being screwed out of the sleeve 45 arranged in the interchangeable head 7. The interchangeable head 7 can then be removed from the shank 5 and can be replaced by a new or reground interchangeable head 7.

The shank 5 may be made, for example, of a high speed steel (HSS) or a case-hardened steel. As a result, the tool 1 acquires axial flexibility. For example, it follows radial deviations in a pre-drilled hole without any problems. This flexibility prevents chipping of the cutting edges. The interchangeable head may be designed in one piece and be made of mechanically resistant materials, for example of carbide, of solid PCD (polycrystalline diamond), solid CBN (cubic boron nitride) or solid CERMET. Interchangeable heads 7 which are tipped with mechanically resistant materials, such as PCD or CBN, for example, can also be readily used.

The configuration or arrangement of the torque-transmitting means arranged between the interchangeable head 7 and the shank 5 is not restricted to three-flute interchangeable heads, as have been described with reference to FIGS. 1 to 9B, but may also be used in one-flute and two-flute interchangeable heads or even in interchangeable heads which have more than three cutting edges.

In summary, it should be emphasized that a firm and rotationally locked connection between interchangeable head and shank can be ensured by the configuration according to the invention of the torque-transmitting means.

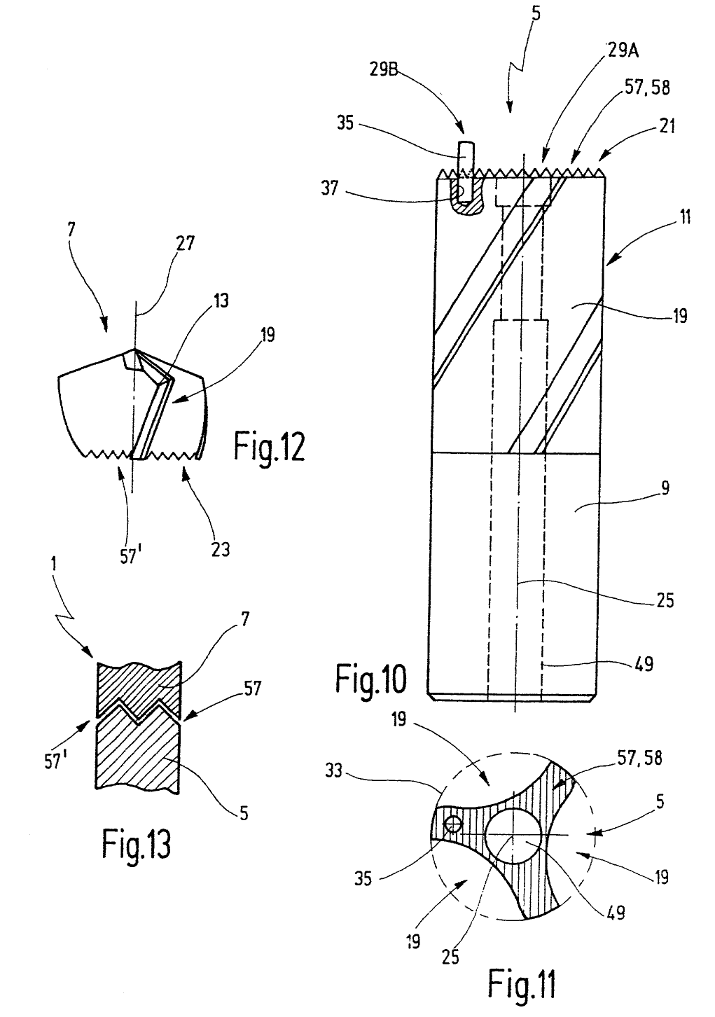

FIG. 10 shows a side view of a further embodiment of a shank 5 of the three-flute drilling/boring tool 1. The same parts are provided with the same reference numerals, and reference is made to the preceding description. The shank 5 in FIG. 10 differs from the shank in FIGS. 4 and 5 particularly in that the parting surface 21 is not flat but is provided with a tooth system 57 which covers the entire parting surface 21, as in FIG. 11, which shows a plan view of the parting surface 21 of the shank 5 of FIG. 10. The tooth system 57 here is a linear-serration tooth system 58, that is, it has rectilinearly running indentations which are designed in a V-shape, as seen in side view. The cross-sectional shape of the indentations/grooves can be varied, and thus is not restricted to the embodiment shown in FIGS. 10 and 11.

In this embodiment, the linear-serration tooth system 58 covers the entire parting surface 21 and forms part of the first torque-transmitting means for the rotationally locked coupling of an interchangeable head 7 to the shank 5. In another embodiment, the tooth system 57 is only over a section of the parting surface 21, preferably in the center region of the shank 5, where its wall thicknesses are greatest.

FIG. 12, in side view, shows an exemplary embodiment of the interchangeable head 7 which is intended for use with the shank 5 shown in FIGS. 10 and 11. At its parting surface 23, the interchangeable head 7 has a tooth system 57′ corresponding to the tooth system 57 of the shank 5, that is a linear-serration tooth system. When the interchangeable head 7 is placed onto the shank 5, the tooth systems 57, 57′ intermesh, providing a rotationally locked coupling between the interchangeable head 7 and the shank 5. The interchangeable head 7 is fixed to the shank 5 in the axial direction by a threaded sleeve 45 arranged on the interchangeable head 7 as shown in FIG. 2, and a threaded tie rod inserted from the rear into the passage 49 in the shank 5 is screwed into the threaded sleeve 45.

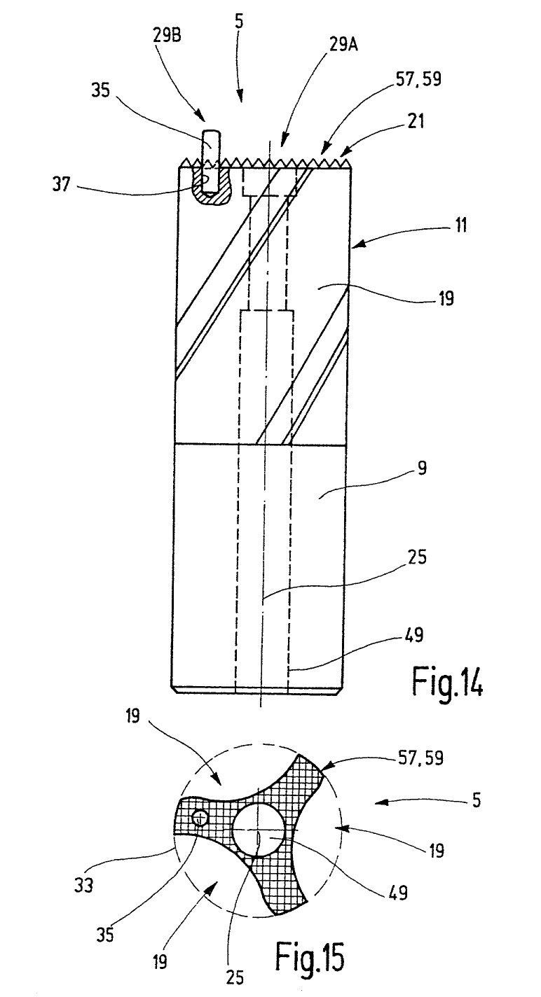

FIG. 13 shows a detail of the three-flute tool 1 described with reference to FIGS. 10 to 12 in the region of the intermeshing tooth systems 57, 57′ (or linear-serration tooth systems). Torque to be transmitted from the shank 5 to the interchangeable head 7 during operation of the tool 1 or from the interchangeable head 7 to the shank 5 during operation of the tool 1 is effected via the tooth flanks of the teeth of the tooth systems 57, 57′ bearing against one another. The relatively large number of intermeshing teeth here cause the overall area of the flanks of the teeth participating in the torque transmission to be relatively large, so that the forces acting thereon, in particular the surface pressure, is correspondingly low. Therefore, even in drilling/boring tools 1 which have only small wall thicknesses in cross section, for example, three-flute drilling/boring tools having a relatively small diameter, damage to the interchangeable head and the shank can safely be avoided even during the transmission of high torques.

Furthermore, in the embodiment of the tool 1 described with reference to FIGS. 10 to 13, a further torque-transmitting means 29B is arranged on the shank 5 which in this case is formed by a circular-cylindrical pin 35, as described with reference to FIG. 4. The primary function of the pin 35 is to position the interchangeable head 7 on the shank 5 in the desired manner. To this end, the interchangeable head 7 has a recess 41 (not shown in FIG. 12), in which the pin 35 engages in the mounted state of the interchangeable head 7. Furthermore, the pin 35 transmits some of the torque directed from the interchangeable head 7 to the shank 5 or from the shank 5 to the interchangeable head 7. The pin 35 is not necessary for transmitting the torques occurring during operation of the tool 1, since these torques can readily be transmitted solely via the tooth systems 57, 57′, and the pin 35 may be dispensed with if need be.

The embodiment of FIGS. 10 to 13 has the advantage that the torque-transmitting means, in particular the tooth systems 57, 57′, can be produced in a simple manner, for example by grinding from the solid material. The tool 1 can therefore be produced in a cost-effective manner.

FIG. 14 shows a side view and FIG. 15 shows a plan view of a further embodiment of a shank 5 for the three-flute drilling/boring tool 1. This differs from FIGS. 10 to 13 merely in that the torque-transmitting means is on the shank 5 and on the interchangeable head 7 (not shown) has a tooth system 57 designed as a cross-serration tooth system 59. The cross-serration tooth systems 59 are designed such that the interchangeable head 7 can be centered positionally accurately on the shank 5. In this case, unlike the linear-serration tooth system, relative slipping of the two parts (shank and interchangeable head) when tooth systems 57 are intermeshing can virtually be ruled out. The cross-serration tooth system 59 is preferably ground into the interchangeable head 7 and into the shank 5. The cross-serration tooth system 59 is formed by longitudinal grooves which are V-shaped in cross section and of which a first group are arranged side by side and parallel to one another. A second group of the V-shaped longitudinal grooves run parallel to one another and transversely to the first group. The cross-sectional shape of the longitudinal grooves can be varied and thus is not restricted to the embodiment in FIGS. 14 and 15.

The embodiment in FIGS. 14 and 15, like that in FIGS. 10 to 13, comprises a further torque-transmitting means formed by a peg/hole connection. The peg is formed by a pin 35 arranged on the shank 5, and the hole is arranged on the associated interchangeable head 7 (not shown).

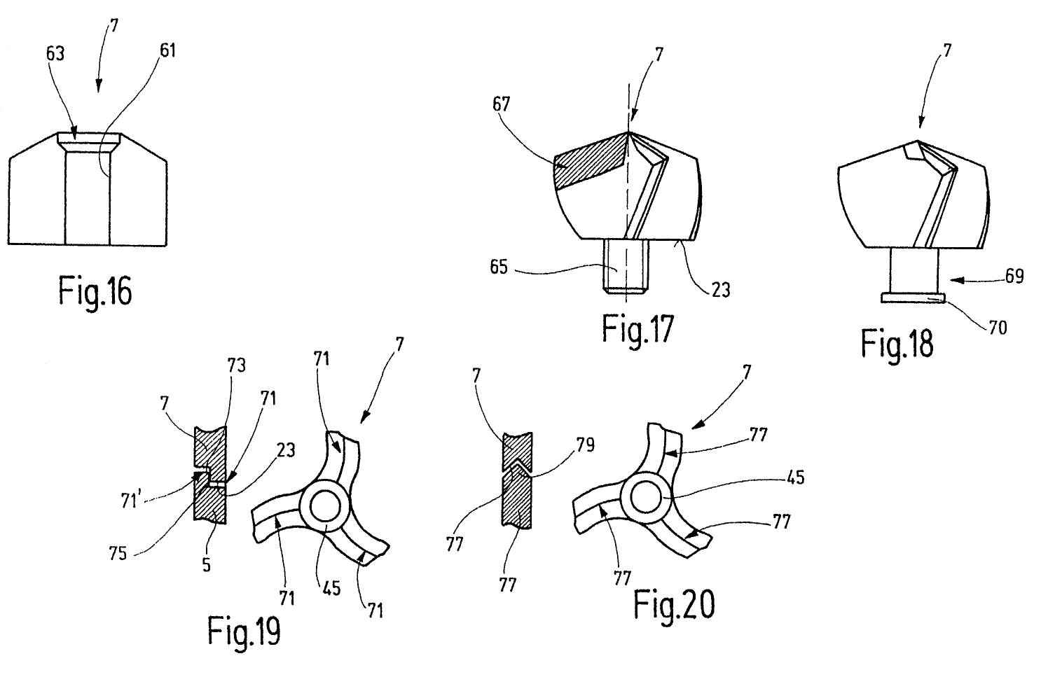

FIGS. 16 to 18 each show a side view of a further embodiment of the three-flute interchangeable head 7. In FIG. 16, the interchangeable head 7 is screwed onto the shank 5 (not shown) from above. To this end, the interchangeable head 7 has a through-opening 61 which runs in the direction of its longitudinal center axis. On the side remote from the shank 5, the head is provided with a recess 63 for accommodating a screw head. The interchangeable head 7 is placed onto the end face of the shank 5, a screw passes through the through-opening 61 and is screwed into a corresponding internal thread on the shank 5 or into retaining means arranged on the shank 5. In the mounted state of the interchangeable head 7, the head of the screw is preferably arranged completely in the recess 63 and thus does not project beyond the end face of the interchangeable head 7 in the axial direction. The torque-transmitting means may comprise, for example, at least one peg/hole connection or a linear- or cross-serration tooth system, as described above.

In the embodiment of the interchangeable head 7 shown in FIG. 17, the interchangeable head 7 has a stud bolt 65 which projects beyond its second parting surface 23 and can be screwed into a corresponding tapped hole or the like in the shank 5. As a result, the interchangeable head 7 is connected to the shank 5 in a rotationally locked manner and is also secured in the axial direction. The hatched area 67 at one of the cutting edges indicates that the interchangeable head 7 is tipped with PCD or CBM, which is also readily possible for all the other embodiments of the interchangeable head.

The embodiment of the interchangeable head 7 shown in FIG. 18 uses a bayonet catch 69, known per se, for the rotationally locked connection between interchangeable head 7 and shank 5. Located on the interchangeable head 7 is a peg which runs concentrically to the longitudinal center axis. A closing part 70 of the bayonet catch 69 is arranged or formed on the peg. In the mounted state of the interchangeable head 7, the closing part 70 engages in a correspondingly formed receptacle in the shank 5 producing a rotationally locked connection and at the same time fixing the interchangeable head 7 in the axial direction on the shank 5.

FIG. 19b shows a bottom view of an exemplary embodiment of the interchangeable head 7 in which first torque-transmitting means comprise at least one step, here a total of three steps 71 are shown, which are made in the second parting surface 23 and are arranged at a radial distance from the rotation axis of the interchangeable head 7. In FIG. 19a, these steps 71 each have a wall 73 running parallel to the longitudinal center axis/rotation axis of the interchangeable head 7. These walls 73 each serve as an abutment for a corresponding wall 75 on the shank 5 for transmitting the torque during operation of the tool 1. As seen in plan view, the walls 73 have a curvature which approximately follows the outer contour of the interchangeable head 7. FIG. 19a shows a detail of the tool 1 in the region of the connecting point between interchangeable head 7 and shank 5. The shank 5 likewise has steps 71′ for forming the walls 75. Torque transmission is therefore effected by positive locking. The walls 73, 75 may also readily be inclined relative to the longitudinal center axis/rotation axis of the interchangeable head 7. It is important that in each case at least one radially outer wall section does not run transversely to the rotation axis of the interchangeable head, which would make torque transmission impossible.

FIG. 20 shows a further embodiment of the interchangeable head 7 in which the torque transmission is effected by positive locking. FIG. 20b shows a bottom view of the interchangeable head 7 in which first torque-transmitting means have a plurality of V-shaped recesses 77 which are made in the second parting surface 23 and are arranged at a radial distance from the longitudinal center axis of the interchangeable head 7. A respective projection 79 on the shank 5 engages in each recess 77, as seen in FIG. 20a, which shows a detail of the tool 1 in the region of the connecting point between interchangeable head 7 and shank 5. The projection 79 is wedge-shaped and tapers to a point in accordance with the shape of the recess 77. The positive-locking connection of FIGS. 20a and 6 is also designated as a prismatic connection.

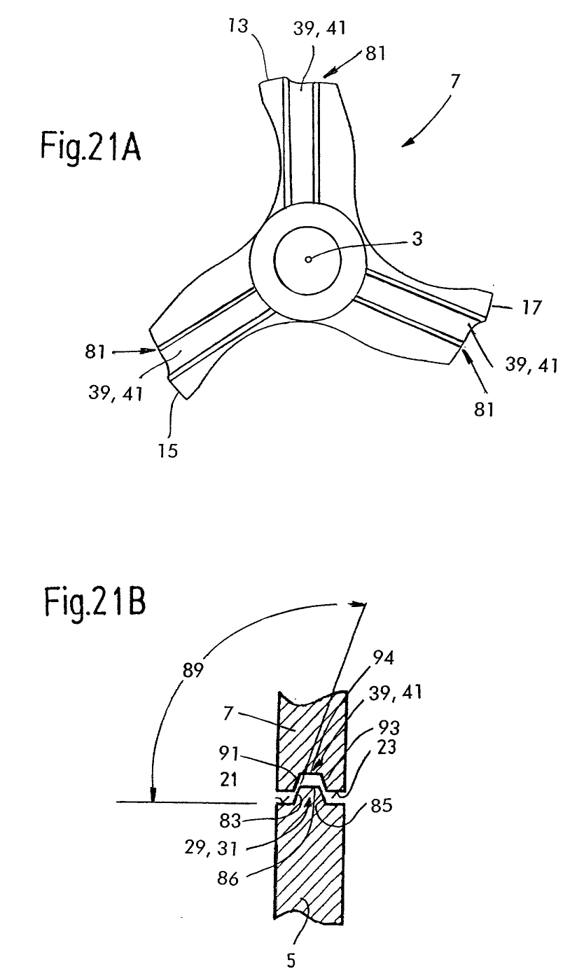

FIGS. 21a and b show a further embodiment of the interchangeable head 7. As in the embodiments in FIGS. 19 and 20, torque transmission is effected by positive locking. In FIG. 21, the tool is a three-flute tool with three spiral flutes and three spiral prominences. A torque-transmitting means is assigned to each spiral prominence. For simplicity, only one torque-transmitting means is dealt with below, as they are similar. FIG. 21b shows a bottom view of the interchangeable head 7. The recess 41 that forms the second torque-transmitting means 39 has a rectilinear longitudinal extent in the radial direction relative to the rotation axis 3 and up to the outer circumferential surface 81 of the drilling/boring tool 1. Since the spiral prominences each have a curved shape while the recesses 41 run rectilinearly, a varying size distance from the spiral flutes is obtained over the length of the recesses 41. This applies to the three projections 31. The projection 31, which forms the first torque-transmitting means 29 of the shank 5, engages in the recess 41 in a positive-locking manner, as seen from FIG. 21a, which shows a detail section of the drilling/boring tool 1 in the region of the connection point between the interchangeable head 7 and the shank 5. In cross section, the projection 31 and the recess 41 are of trapezoidal design, that is the outer contour of the projection 31 and the inner contour of the recess 41 each have trapezoidal shape cross section and are thus of polygonal design. The trapezoidal shape is arranged such that the walls 83, 85 adjoining the first parting surface 21 run at an angle toward one another, starting from the first parting surface 21, so that the distance between the walls 83, 85 is in each case smaller on their side remote from the first parting surface 21 than on their side facing the first parting surface 21. In this embodiment, therefore, the walls 83, 85 are not perpendicular to the first parting surface 21 but are arranged inclined at an obtuse angle 89. In this embodiment, the angle 89 is about 105°0. The angle 89 may also have a larger or smaller value or may also be 90°. In the 90° case, the trapezoidal shape is dispensed with. The top surface 86 of the trapezoid runs parallel to the parting surface 21.

The inner contour of the recess 41 corresponds to the outer contour of the projection 31, that is the walls 91, 93 and 94 of the recess 41, with regard to position and length, correspond to the walls 83, 85 and 86 of the projection 31. The height of the projection corresponds to the depth of the recess, so that the parting surfaces 21, 23 bear against one another in the assembled state. It is possible for the walls 83, 85 of the projection 31 and/or the projection height and/or the recess depth to be selected such that, in the mounted state of the interchangeable head 7, a gap remains between the first parting surface 21 and the second parting surface 23 and/or between the wall 86 of the projection 31 and the wall 94 forming the base of the recess 41.

The entire torque-transmitting means shown in this embodiment comprises a total of three projections 31 and recesses 41, which in each case correspond to one another and are uniformly distributed circumferentially at angular distances of 120°. In the region of their respective parting surface 21 or 23, the projections 31 and recesses 41 have such a large area that, at the shank 5 and at the interchangeable head 7, respectively, as seen in cross section, there are relatively small distances from the spiral flutes, to provide a firm and reliable connection between the interchangeable head 7 and the shank 5. An especially reliable and defined connection is produced. In addition, on account of the geometrically simple form of the torque-transmitting means, it is technically simple to manufacture.

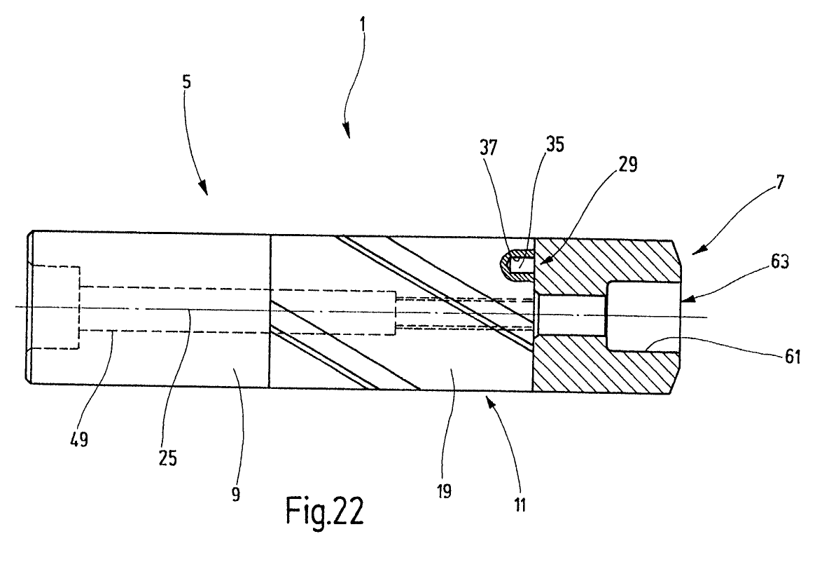

FIG. 22 shows a further embodiment of the three-flute drilling/boring tool 1, which differs from the tool of FIG. 1 merely by comprising an interchangeable head 7 as in FIG. 16. The interchangeable head 7 is screwed from the front to the shank 5 for securing in the axial direction. To this end, a screw (not shown) is inserted through the through-opening 61 in the interchangeable head 7 and is screwed into a threaded tie rod (not shown) arranged in the passage 49 of the shank 5.

The shank 5 of the tool shown in FIG. 22 may be made, for example, of a steel having the designation 30CrNiMo8, whereas the interchangeable head 7 is made of solid carbide having the designation K30. Of course, other materials may also be readily used for the interchangeable head and the shank.

The different torque-transmitting means described above can be combined with one another. A plurality of torque-transmitting means of different configuration may be provided on one tool, wherein these torque-transmitting means connect the interchangeable head and the shank in a rotationally locked manner and, if needed, to fix them at the same time in the axial direction. The configuration of the torque-transmitting means according to the invention is also not restricted to three-flute drilling/boring tools. The torque-transmitting means described above may therefore also be readily provided in drilling and/or boring tools which have an interchangeable head with only one cutting edge, two cutting edges or possibly more than three cutting edges, for example four cutting edges.

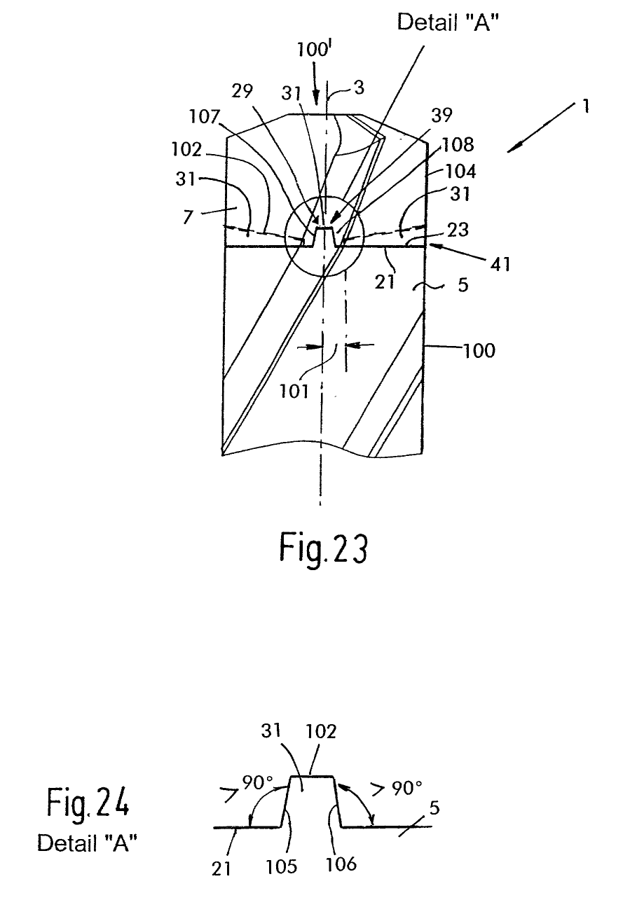

FIGS. 23 to 30 show further exemplary embodiments of a drilling and/or boring tool 1 according to the invention. These Figures particularly show boring tools, since the interchangeable head 7 is fastened to the shank 5 by fastening means, designed as a screw, which passes through a central through opening of the interchangeable head 7, running along the longitudinal center axis 3. This screw is supported with a head on the interchangeable head 7 and the screw thread is screwed into a central tapped hole of the shank 5. The tapped hole runs along the longitudinal center axis 3. For clarity, details of this fastening means are not shown in FIGS. 23 to 30.

With regard to the torque-transmitting means for the rotationally locked coupling of the shank 5 and interchangeable head 7, the embodiments of the drilling/boring tool 1 in FIGS. 23 to 30 correspond to the embodiment of FIG. 21 and the explanations with regard to FIG. 21 apply. Only the special features of the embodiments of FIGS. 23 to 30 relative to the embodiment of FIG. 21 are dealt with below. These features consist in particular in the torque-transmitting means having first torque-transmitting means 29 which are projections 31 on the shank 5. These are preferably a plurality of projections 31 which are uniformly arranged offset at angles around the longitudinal center axis 3 and are formed in one piece with the shank 5. Three projections 31 offset from one another by 120° are preferable.

FIG. 23 shows projections 31 starting from the outer margin 100 of the shank 5 and extending radially in the direction of the longitudinal center axis 3. They are at a distance 101 from the longitudinal center axis 3. As a result, there is sufficient space for the engagement of the fastening means designed as a screw (not shown) for fastening the interchangeable head 7 to the shank 5. The head of the screw is accommodated in an axial stepped hole 100′. It is especially important that the height of each projection 31 is not constant over its longitudinal extent (radial direction) But, from the outside to the inside, the height becomes smaller. Thus, the height of the projection 31 at the margin 100 has the largest value and then decreases continuously, so that there is a smaller height at the opposite end of each projection 31. The arrangement may be such that the height at the inner end is determined by the distance 101 by the flat, sloping surface 102 of each projection 31 inclined such that an imaginary line extends up to the level of the intersecting point of parting surface 21 and longitudinal center axis 3 and likewise crosses this point of intersection. Due to the distance 101 from the longitudinal center axis 3, a residual height is therefore obtained at the inner end for each projection 31.

On the whole, on account of the sloping course of the surface 102 of each projection 31, there is a larger projection height in the outer region than in the inner region. The second torque-transmitting means 39 is a groove-shaped recess 41 of the interchangeable head assigned to each projection 31. This makes it possible for larger torques to be transmitted in the peripheral region of the drilling/boring tool 1 than in the region further on the inside, which corresponds to the stress characteristic.

The recess 41 is designed in accordance with the external shaping of the associated projection 31 and thus has a sloping groove root 103. The depth of the recess 41 in the region of the margin 104 of the interchangeable head 7 is correspondingly larger than in the region further on the inside. The groove root 103 is likewise a sloping plane and therefore corresponds to the course of the surface 102 of the associated projection 31. FIG. 24 shows that, as viewed in the direction of the surface 102 starting from the parting surface 21, the two sides 105 and 106 of each projection 31 converge. Each side 105, 106 is at an angle >90°, particularly within the range of 95° to 120° , and preferably 100°, to the associated parting surface 21. The two angles in FIG. 24 are the same size.

The sides 107, 108 of the recess 41 in FIG. 23 is adapted in shape to the associated projection 31, that is the sides 107, 108 of the recess 41 are sloping planes which converge toward the groove root 103. The respective angle between the second parting surface 23 of the interchangeable head 7 and the associated side 107 or 108 of the recess 41 is correspondingly designed to be >90°, and preferably within the range of 95° to 120°, particular 100°.

The angles of recess 41 and projection 31 are the same size.

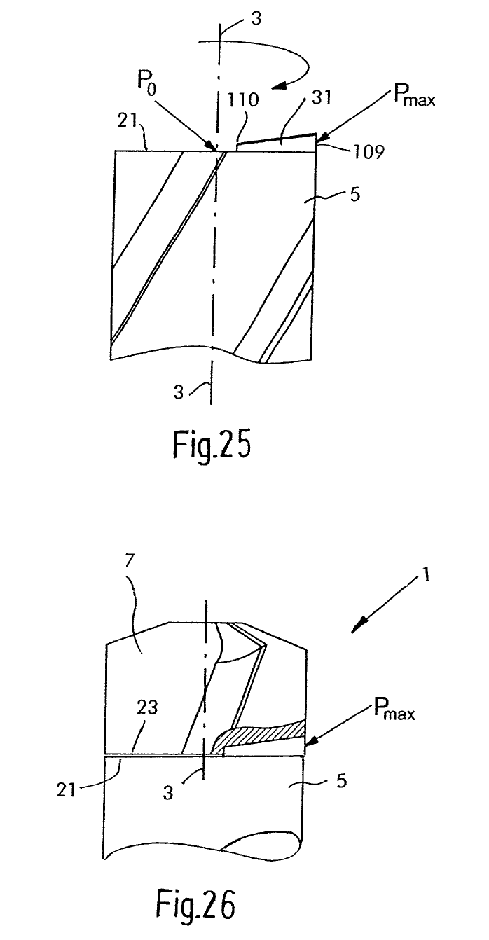

FIG. 25 illustrates that when torque is transmitted from the shank 5 to the interchangeable head 7 (not shown in FIG. 25), the peripherally outer end 109 of each projection 31 applies the maximum torque pₘₐₓ, whereas the inner end 110 is acted upon with a lower torque. The zero torque P₀, is present in the region of the longitudinal center axis 3. Since this point is at the distance 101 from the inner end 110, the sides 106 or 107 of the projection 31 transmit a corresponding torque in the region of the end 110. This torque increases continuously outward in the radial direction.

FIG. 26 illustrates the aforesaid, with the interchangeable head 7 being assigned there to the shank 5.

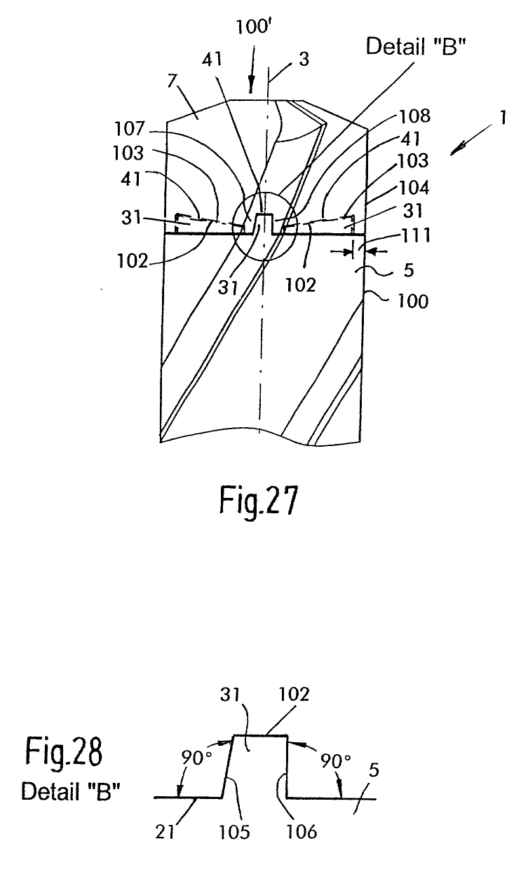

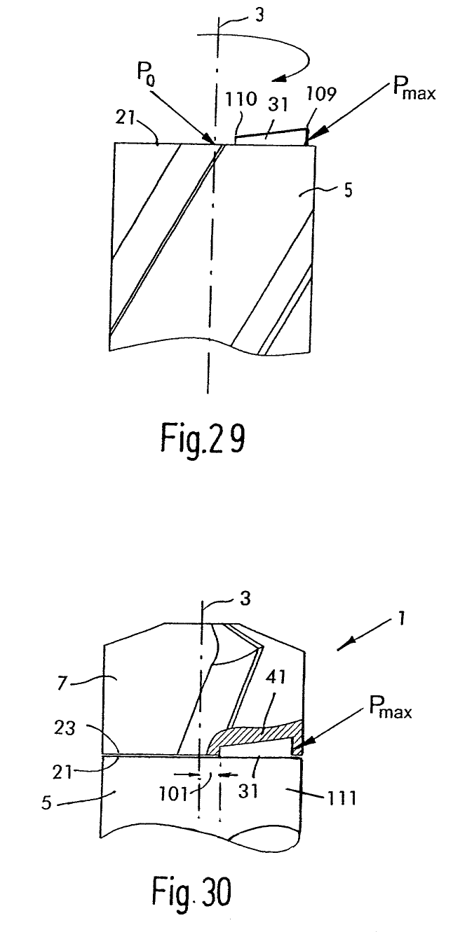

The embodiment in FIGS. 27 to 30 essentially corresponds to the embodiment in FIGS. 23 to 26, so that reference is made to the explanations. The difference is merely that the projections 31 and the corresponding recesses 41 do not extend up to the outer margin 100 and 104, respectively. Instead, there is a radial distance 111 in from these margins. The projection 31 and recess 41 cannot be seen from outside the tool. FIG. 29 illustrates that the maximum torque Pₘₐₓ in this respect has to be applied from the end 109, which is correspondingly further on the inside, of the projection 31 or of the recess 41, respectively.

All the embodiments described above including the last-mentioned embodiment may have flank angles of the projection 31 and corresponding angles of the sides of the recess 41 as can be seen from FIG. 24. Alternatively, it is also possible for the angles according to FIG. 28 to be realized at the projection 31 and the recess 41. This means that the side 105 of the projection is at an angle >90°, in particular 95° to 120°, and more particularly 100°, to the associated parting surface 21. The other side 106 is at an angle of 90° to the associated parting surface 21. The sides 107 and 108 of the recess 41 are configured in a corresponding manner, that is there is likewise an angle >90° and then a 90° angle.

In particular, in the embodiment of FIG. 28, torque may be transmitted from the surface 106 of the projection 31 to the associated side 108, likewise having a 90° angle, of the recess 41, that is the projection 31 transmits the torque with a side which is at an angle of 90° to the parting surface 21 to a side 108 of the recess 41 which likewise has a 90° angle. This provides no component force which attempts to separate the interchangeable head 7 from the shank 5 during the torque transmission. In this respect, optimum torque transmission is realized. However, this likewise ensures that the surface 102 of the projection 31 and the groove root 103 of the recess 41 slope in accordance with the explanations with respect to FIG. 23.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

46. A drilling or boring tool having at least one cutting edge, the tool comprising:
a shank with a spiral-flute region along the shank, the shank having an end and a first parting surface at the end thereof;
an interchangeable head including an end with a second parting surface disposed for cooperating with the first parting surface of the shank, the head having an end-face with a geometry;
torque transmitting means between the shank and the interchangeable head when the first and second parting surfaces are together.

47. The tool of claim 46, wherein there are a plurality of the cutting edges toward the end face of the head.

48. The tool of claim 46, wherein there is an imaginary circle determined by the diameter of the drill or of the bore hole which the tool will form; and
the torque transmitting means is arranged at a distance radially in from the imaginary circle.

49. The tool of claim 46, wherein the first parting surface of the shank is a flat surface and the second parting surface of the interchangeable head is a flat surface and the first and second parting surfaces bear flat against one another with the head mounted to the shank.

50. The tool of claim 46, wherein the first and the second parting surfaces lie in a parting plane between the shank and the head, the parting plane running essentially orthogonally to the longitudinal center axis of the tool.

51. The tool of claim 46, wherein the torque transmitting means comprises:
a first torque transmitting means comprising at least one projection from one of the first and second parting surfaces,
a second torque transmitting means comprising at least one respective recess in the other of the first and second parting surfaces,
wherein the projection is arranged in the recess with at most little play with the head mounted to the shank.

52. The tool of claim 51, wherein the tool has a longitudinal center axis, and the first and second torque transmitting means are each at a radial distance outward from the longitudinal center axis of the tool.

53. The tool of claim 51, wherein the projection and the recess are respectively so shaped so that the head is centered relative to the shank when the head is attached to the shank.

54. The tool of claim 51, wherein the projection has an outer contour, the recess has an inner contour and the outer and inner contours correspond.

55. The tool of claim 51, wherein the projection is formed in one piece with a respective one of the head or the shank on which the projection is defined.

56. The tool of claim 51, wherein the projection comprises a pin projecting from the respective parting surface and the recess comprises a receptacle in the other of the parting surfaces, and the pin and receptacle are so shaped so that the pin can be received in the receptacle.

57. The tool of claim 51, wherein the projection and the recess therefor each have a circular cross-section.

58. The tool of claim 51, wherein there are a plurality of sets of the first and second torque transmitting means, with the first and second torque transmitting means of each set being in engagement.

59. The tool of claim 58, wherein the sets of first and second torque transmitting means are uniformly distributed circumferentially around the tool.

60. The tool of claim 58, wherein at least one of the sets of first and second torque transmitting means has a shape or a size differing from the other sets of the first and second torque transmitting means.

61. The tool of claim 51, wherein the torque transmitting means on the shank and on the head each include at least a tooth system intermeshing with the tooth system on the other of the torque transmitting means with the head mounted on the shank.

62. The tool of claim 61, wherein at least one of the tooth systems comprises a linear serration tooth system.

63. The tool of claim 61, wherein at least one of the tooth systems comprises a cross-serration tooth system.

64. The tool of claim 61, wherein the torque transmitting means further comprises at least one projection from one of the first and second parting surfaces and at least one recess in the other of the parting surfaces, with the projection and recess being so disposed that in the mounted state of the head on the shank, the projection is in the recess and the tooth system on the head intermeshes with the tooth system on the shank.

65. The tool of claim 46, wherein the head also has a spiral-flute region; a connection between the head and the shank, and the shank and the head have the same cross-sectional areas at least at the connections.

66. The tool of claim 46, further comprising a connection between the head and the shank comprised of a screw connection or a bayonet catch connection.

67. The tool of claim 46, wherein the shank and the head have respective end faces toward one another and the end faces have respective profiles that face toward each other and form the torque transmitting means.

68. The tool of claim 51, wherein the projection and the respective recess are respectively shaped to have a longitudinal extent in the radial direction toward the rotation axis.

69. The tool of claim 68, wherein the projection and the respective recess are of rectilinear design in the direction of longitudinal extent.

70. The tool of claim 68, wherein the tool has an outer circumferential surface and both the projection and the recess extend radially out to the outer circumferential surface of the tool.

71. The tool of claim 51, wherein each projection has an outer contour and the respective recess has an inner contour, and the inner and outer contours are both polygonally shaped for enabling the projection to be installed in the recess in an accurately fitted manner.

72. The tool of claim 71, wherein the outer contour of the projection and the inner contour of the recess are trapezoidal in shape.

73. The tool of claim 46, wherein the torque transmitting means on the shank and on the head each include at least a tooth system intermeshing with the tooth system of the other of the torque transmitting means, when the head is mounted on the shank.

74. The tool of claim 73, wherein the torque transmitting means further comprises a first torque transmitting means comprising at least one projection from one of the first and second parting surfaces and a second torque transmitting means comprising a respective recess in the other of the first and second parting surfaces wherein the projection is arranged in the recess with at most little play with the head mounted to the shank.

75. The tool of claim 51, wherein there are a plurality of the projections spaced apart and a plurality of the recesses, each respectively for one of the plurality of projections.

76. The tool of claim 75, wherein the projections are at uniform angular distances from one another, and the respective recesses are at respective corresponding distances from one another.

77. The tool of claim 76, wherein there are three of the projections and a respective three of the recesses which are offset from one another by an angle of 120°.

78. The tool of claim 68, wherein the shank and the head have respective outer margins and the torque transmitting means start from the outer margins of the shank and the head.

79. The tool of claim 78, wherein the torque transmitting means extend from the outer margins to an imaginary circumferential line and the imaginary line has a center point on a longitudinal center axis on the tool, whereby the torque transmitting means are spaced at a radial distance from the longitudinal center axis.

80. The tool of claim 68, wherein the height of the projection above the respective parting surface becomes smaller in the radial direction from the outer margin toward the center axis.

81. The tool of claim 80, where the height of the projection decreases continuously in the radial direction from the outer margin to the center axis.

82. The tool of claim 81, wherein the depth of the recess decreases in the radial direction from the outer margin toward the center axis.

83. The tool of claim 80, wherein the depth of the recess decreases continuously in the radial direction from the outer margin toward the center axis.

84. The tool of claim 51, wherein at least one of the projections has essentially radially running sides; and the radially running sides converge in the axial direction toward the head.

85. The tool of claim 84, wherein the sides of the at least one projection are flat surfaces.

86. The tool of claim 84, wherein each one of the projections has opposite sides which are at an angle to the respective parting surface which is greater than 90°, or one side of the projection has an angle of 90° to the parting surface while the other side of the projection has an angle greater than 90° to the parting surface, for causing the sides of the projection to converge.

87. The tool of claim 84, wherein the projections have a cross-section which has a symmetrical trapezoid shape.

88. The tool of claim 46, wherein the torque transmitting means comprises a first torque transmitting means comprising at least one projection from one of the first and second parting surfaces and a second torque transmitting means comprising a respective recess in the other of the first and second parting surfaces,
wherein the projection is arranged in the recess and the recess is adapted in shape to the projection for radial and axial interlocking of the head and the shank free of play.

89. The tool of claim 46, further comprising releaseable fastening means for holding the head to the shank in an interchangeable manner.

90. The tool of claim 89, wherein the fastening means comprises a stud bolt or a screw;
a central through opening in the head through which the bolt or screw passes; a head or step on the interchangeable head for supporting the bolt or screw on the head and a central tapped hole in the shank for receiving the fastening means.

91. The tool of claim 90, wherein the head or step of the fastening means is sunk in the interchangeable head.
